(19) United States
(12) Patent Application Publication
(10) Pub. No.: US 2010/0141734 A1
(43) Pub. Date: Jun. 10, 2010

(54) Imaging apparatus and optical axis correction method of imaging apparatus

(75) Inventors: Manabu Tani, Ibaraki-shi (JP); Keisuke Taguchi, Ibaraki-shi (JP); Ikuo Shinta, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., Ibaraki-shi (JP)

(21) Appl. No.: 12/588,761

(22) Filed: Oct. 27, 2009

(30) Foreign Application Priority Data
Oct. 28, 2008 (JP) 2008-276438
Feb. 20, 2009 (JP) 2009-037668

(51) Int. Cl. H04N 7/00

(52) U.S. Cl. 348/36; 348/E07.001

(57) ABSTRACT

An imaging apparatus includes a plurality of imaging units each having a lens and an image pickup device. At least one of the imaging units is a wide-angle imaging unit having a lens with a wider angle of view, and at least another one is a zoom imaging unit having a lens with a narrower angle of view and a higher magnification and mounted rotatably to the imaging apparatus. The imaging apparatus includes a driving unit that rotates the zoom imaging unit to change an imaging range of the zoom imaging unit, an image comparison unit that compares a partial image of a wide-angle image captured by the wide-angle imaging unit and a magnified image captured by the zoom imaging unit, and an optical axis information update unit that updates optical axis information of the zoom imaging unit based on a comparison result of the image comparison unit.

### BACKGROUND OF THE INVENTION

1. Field of the Invention

The present invention relates to an imaging apparatus and an optical axis correction method of the imaging apparatus and, particularly, to an imaging apparatus such as a surveillance camera and an optical axis correction method of the imaging apparatus.

2. Description of Related Art

A surveillance camera that includes a wide-angle imaging unit and a zoom imaging unit has been known. The wide-angle imaging unit images a relatively wide range. On the other hand, the zoom imaging unit images a part of an imaging range of the wide-angle imaging unit with a high magnification. Further, the zoom imaging unit can be driven. The surveillance camera can thereby image a desired part of a surveillance range. For example, by driving the zoom imaging unit, it is possible to track and image a target moving through the surveillance range. In addition, a surveillance camera that uses two or more imaging units with different angles of view is known.

For example, Japanese Unexamined Patent Application Publication No. 2000-341574 discloses a camera control system that displays a frame indicating a range imaged by a zoom imaging unit on a display screen of an image captured by a wide-angle imaging unit.

Such an imaging apparatus that includes a plurality of imaging units with different magnifications has an advantage that it is possible to display a detailed image of a desired part of a surveillance range while watching a whole area of the surveillance range.

For another example, Japanese Unexamined Patent Application Publication No. 2006-041939 discloses a surveillance apparatus that performs surveillance by using a plurality of imaging units arranged in such a way that a part of an imaging range overlaps with each other. The surveillance apparatus detects the position of a moving object three-dimensionally.

For yet another example, Japanese Unexamined Patent Application Publication No. 2004-355601 discloses a surveillance apparatus that captures a color image by using two left and right imaging units. Further, the surveillance apparatus calculates a color ratio histogram of the center of mass of a moving subject contained in the color image for each of successive frames. The surveillance apparatus then compares the color ratio histograms and determines whether the moving subject in each frame is the same moving subject or not.

However, because a sensor for detecting a reference position of the zoom imaging unit is necessary in the imaging apparatus that includes the driving unit as described above, costs are high. Further, wiring from the sensor is necessary, which complicates the structure. Furthermore, even when the sensor is mounted, if a stepping motor is used as a component of the driving unit, there is a disadvantage that, in the event of loss of synchronization and displacement, the displacement cannot be corrected unless the zoom imaging unit is set back to the reference position.

### SUMMARY OF THE INVENTION

In view of the foregoing, it is desirable to provide an imaging apparatus and an optical axis correction method of the imaging apparatus capable of correcting displacement of a zoom imaging unit with a simple structure and at low costs.

According to an embodiment of the present invention, there is provided an imaging apparatus including a plurality of imaging units each having a lens and an image pickup device. At least one of the plurality of imaging units is a wide-angle imaging unit having a lens with a wider angle of view than another imaging unit, and at least one of the plurality of imaging units is a zoom imaging unit having a lens with a narrower angle of view and a higher magnification than the wide-angle imaging unit and mounted rotatably to the imaging apparatus. The imaging apparatus includes a driving unit that rotates the zoom imaging unit so as to change an imaging range of the zoom imaging unit, an image comparison unit that compares a partial image of a wide-angle image captured by the wide-angle imaging unit and a magnified image captured by the zoom imaging unit, and an optical axis information update unit that updates optical axis information of the zoom imaging unit based on a comparison result of the image comparison unit. In this configuration, even when a loss of synchronization occurs in a stepping motor for driving the zoom imaging unit and displacement exists in the optical axis information of the zoom imaging unit, for example, it is possible to easily correct the displacement. Further, because a sensor or the like is not necessary, it is possible to correct the displacement of the optical axis information of the zoom imaging unit at low costs. Furthermore, wiring or the like can be eliminated, which simplifies the configuration.

The image comparison unit preferably performs mosaicing of the wide-angle image and the magnified image to substantially equalize a viewing angle per pixel, compares the partial image of the wide-angle image and the magnified image and derives a degree of agreement in tone in pixels between the images.

Further, the optical axis information update unit preferably updates the optical axis information of the zoom imaging unit based on coordinate information of the partial image having a maximum value of the degree of agreement in tone in pixels between the partial image of the wide-angle image and the magnified image.

If there is one maximum value of the degree of agreement in tone in pixels between the partial image of the wide-angle image and the magnified image, the optical axis information update unit preferably updates the optical axis information of the zoom imaging unit based on coordinate information of the partial image having the maximum value. This prevents an increase in displacement of the optical axis information of the zoom imaging unit due to inappropriate update of the optical axis information of the zoom imaging unit.

Alternatively, if a difference between a maximum value of the degree of agreement in tone in pixels between the partial image of the wide-angle image and the magnified image and a second maximum value of the degree of agreement is equal to or larger than a threshold, the optical axis information update unit preferably updates the optical axis information of the zoom imaging unit based on coordinate information of the partial image having the maximum value. This prevents an increase in displacement of the optical axis information of the zoom imaging unit due to inappropriate update of the optical axis information of the zoom imaging unit.

The optical axis information update unit preferably updates the optical axis information of the zoom imaging unit at regular time intervals.

It is preferred that the imaging apparatus further includes a moving subject detection unit, and the image comparison unit compares the partial image in a range where a moving subject is detected by the moving subject detection unit within the wide-angle image and the magnified image. In this configuration, because comparison with the magnified image is made only in the range where the moving subject is detected within the wide-angle image, it is possible to significantly reduce the time for update processing.

It is also preferred that the imaging apparatus further includes a light shielding element that shields at least part of a range that can be imaged by the zoom imaging unit in an arc shape, and a reference position acquisition unit that acquires a reference position of the zoom imaging unit based on coordinate information of the light shielding element appearing in the magnified image captured by the zoom imaging unit. It is thereby possible to easily derive the reference position of the zoom imaging unit with respect to camera housing by using the magnified image of the zoom imaging unit and the light shielding element.

It is also preferred that the imaging apparatus further includes an image storage unit that stores image data captured by the zoom imaging unit and position information of the image data obtained from a rotating state of the zoom imaging unit in association with each other, and an image composition unit that combines a plurality of image data and generates image data over a wide range based on a plurality of image data with different imaging ranges and the position information of the image data stored in the image storage unit. It is thereby possible to track a moving subject and capture an image in the vicinity of the moving subject with a high magnification. It is thus possible to track a moving subject and performs detailed imaging.

It is also preferred that the imaging apparatus further includes an initialization control unit that controls initialization processing that divides a whole area of an imaging range of the wide-angle imaging unit into a plurality of imaging ranges, sequentially images the plurality of imaging ranges using the zoom imaging unit by rotating the zoom imaging unit using the driving unit, and stores a plurality of image data captured by the zoom imaging unit in association with the position information of the image data into the image storage unit.

According to another embodiment of the present invention, there is provided an imaging apparatus including a plurality of imaging units each having a lens and an image pickup device. At least one of the plurality of imaging units is a wide-angle imaging unit having a lens with a wider angle of view than another imaging unit, and at least one of the plurality of imaging units is a zoom imaging unit having a lens with a narrower angle of view and a higher magnification than the wide-angle imaging unit and mounted rotatably to the imaging apparatus. The imaging apparatus includes a driving unit that rotates the zoom imaging unit so as to change an imaging range of the zoom imaging unit, and a light shielding element that shields at least part of a range that can be imaged by the zoom imaging unit in an arc shape.

It is preferred that the imaging apparatus further includes a reference position acquisition unit that acquires a reference position of the zoom imaging unit based on coordinate information of the light shielding element appearing in a magnified image captured by the zoom imaging unit. It is thereby possible to easily derive the reference position of the zoom imaging unit with respect to camera housing by using the magnified image of the zoom imaging unit and the light shielding element.

It is also preferred that the imaging apparatus further includes an image storage unit that stores image data captured by the zoom imaging unit and position information of the image data obtained from a rotating state of the zoom imaging unit in association with each other, and an image composition unit that combines a plurality of image data and generates image data over a wide range based on a plurality of image data with different imaging ranges and the position information of the image data stored in the image storage unit. It is thereby possible to track a moving subject and capture an image in the vicinity of the moving subject with a high magnification. It is thus possible to track a moving subject and performs detailed imaging.

It is also preferred that the imaging apparatus further includes an initialization control unit that controls initialization processing that divides a whole area of an imaging range of the wide-angle imaging unit into a plurality of imaging ranges, sequentially images the plurality of imaging ranges using the zoom imaging unit by rotating the zoom imaging unit using the driving unit, and stores a plurality of image data captured by the zoom imaging unit in association with the position information of the image data into the image storage unit.

According to another embodiment of the present invention, there is provided an optical axis correction method of an imaging apparatus including a wide-angle imaging unit and a zoom imaging unit with a narrower angle of view and a higher magnification than the wide-angle imaging unit, the method including steps of capturing a wide-angle image by the wide-angle imaging unit, capturing a magnified image by the zoom imaging unit, performing mosaicing of the wide-angle image and the magnified image to substantially equalize a viewing angle per pixel, extracting a partial image from the mosaiced wide-angle image, comparing the partial image and the mosaiced magnified image and deriving a degree of agreement in tone in pixels between the images, and updating optical axis information of the zoom imaging unit based on the degree of agreement. In this method, even when a loss of synchronization occurs in a stepping motor for driving the zoom imaging unit and displacement exists in the optical axis information of the zoom imaging unit, for example, it is possible to easily correct the displacement. Further, because a sensor or the like is not necessary, it is possible to correct the displacement of the optical axis information of the zoom imaging unit at low costs. Furthermore, wiring or the like can be eliminated, which simplifies the configuration.

It is preferred that the comparing step compares the partial image in a range where a moving subject is detected within the wide-angle image and the magnified image. In this method, because comparison with the magnified image is made only in the range where the moving subject is detected within the wide-angle image, it is possible to significantly reduce the time for update processing.

According to the embodiments of the present invention described above, it is possible to provide an imaging apparatus and an optical axis correction method of the imaging apparatus capable of correcting displacement of a zoom imaging unit with a simple structure and at low costs.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a perspective view showing an example of a twin-lens camera according to a first embodiment of the present invention;

FIG. 2 is a block diagram showing a schematic configuration of a twin-lens camera according to the first embodiment of the present invention;

FIG. 3 is a view showing a relationship between an imaging range of a wide-angle imaging unit and an imaging range of a zoom imaging unit;

FIG. 4 is a view to describe coordinates of a partial image in a wide-angle image which is extracted from the wide-angle image;

FIG. 5 is a flowchart to describe an optical axis correction method of a twin-lens camera according to the first embodiment of the present invention;

FIG. 6 is a block diagram showing a schematic configuration of a twin-lens camera according to a second embodiment of the present invention;

FIG. 7 is a view to describe coordinates of a range where a moving subject is detected in a wide-angle image;

FIG. 8 is a flowchart to describe an optical axis correction method of a twin-lens camera according to the second embodiment of the present invention;

FIG. 9 is a view to describe a positional relationship between a light shielding unit and a zoom imaging unit in a twin-lens camera according to a third embodiment of the present invention;

FIG. 10 is a block diagram showing a schematic configuration of a twin-lens camera according to the third embodiment of the present invention;

FIG. 11A shows a magnified image when a zoom imaging unit is driven to an upper limit position.

FIG. 11B shows a magnified image when a zoom imaging unit is driven to a lower limit position.

FIG. 11C shows a magnified image when a zoom imaging unit is driven to a left limit position.

FIG. 11D shows a magnified image when a zoom imaging unit is driven to a right limit position.

FIG. 12 is a flowchart to describe a method of deriving a reference position of a zoom imaging unit;

FIG. 13 is a block diagram showing a schematic configuration of a twin-lens camera according to a fourth embodiment of the present invention; and

FIG. 14 is a view showing a relationship between an imaging range of a wide-angle imaging unit and an imaging range of a zoom imaging unit according to the fourth embodiment of the present invention.

### DESCRIPTION OF THE PREFERRED EMBODIMENTS

Exemplary embodiments of the present invention are described hereinafter in detail with reference to the drawings. The present invention, however, is not limited to the following embodiments.

### First Embodiment

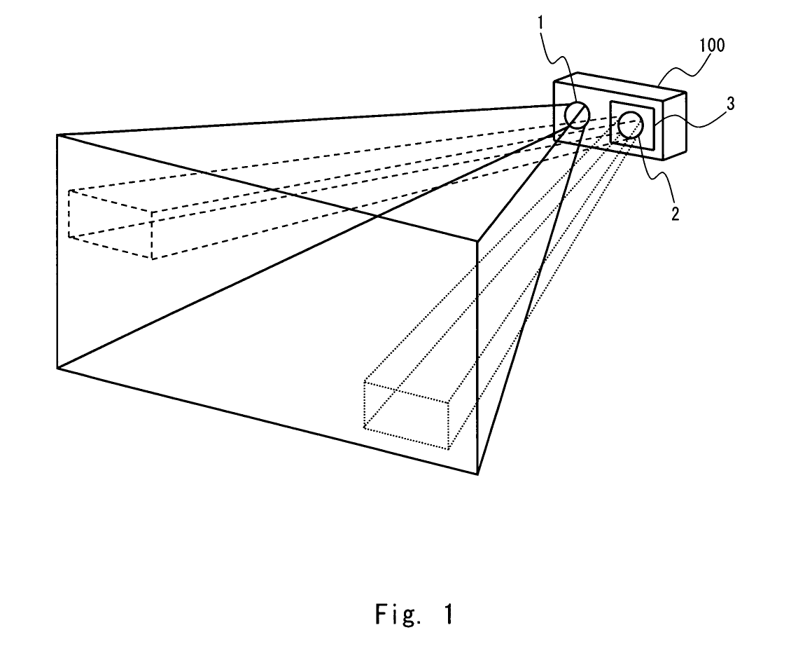

An imaging apparatus (twin-lens camera) according to a first embodiment of the present invention is described hereinafter. Referring to FIG. 1, a twin-lens camera 100 includes a plurality of imaging units. Each of the imaging units includes a lens (not shown), an image pickup device (not shown), and so on. The image pickup device may be a solid-state image pickup device such as a charge coupled device (CCD) or a complementary metal-oxide semiconductor (CMOS), for example.

Specifically, the twin-lens camera 100 includes a wide-angle imaging unit 1 and a zoom imaging unit 2. In FIG. 1, an imaging range of the wide-angle imaging unit 1 is indicated by a full line, and examples of an imaging range of the zoom imaging unit 2 are indicated by a dashed line and a doted line.

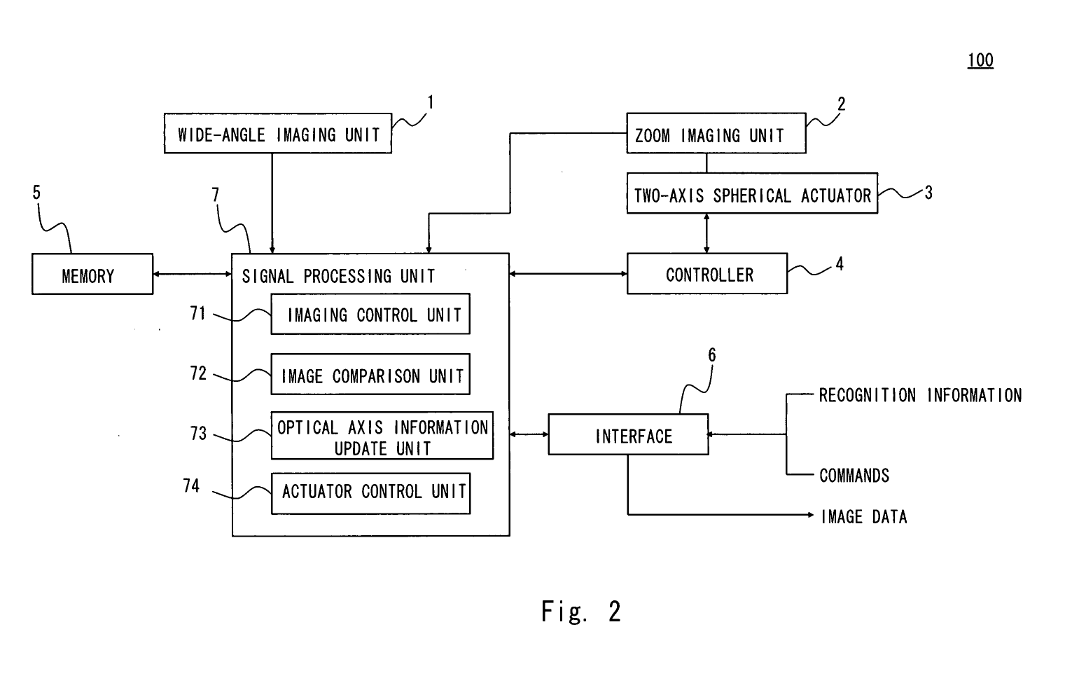

Referring to FIG. 2, the twin-lens camera 100 further includes a two-axis spherical actuator 3 (driving unit), a controller 4, a memory 5 (image storage unit), an interface 6, a signal processing unit 7, and so on.

The wide-angle imaging unit 1 includes a lens with a wider angle of view than the zoom imaging unit 2. Specifically, the wide-angle imaging unit 1 includes a coupling lens with an angle of view of 120 degrees (π/180×120 rad) as an imaging lens. Further, the wide-angle imaging unit 1 includes an image pickup device with 1/7.4 inches and 640×480 pixels (330,000 pixels) as an image pickup device.

The zoom imaging unit 2 includes a lens with a narrower angle of view and a higher magnification than the wide-angle imaging unit 1. Specifically, the zoom imaging unit 2 includes a coupling lens with an angle of view of 30 degrees (n/180×30 rad) as an imaging lens. Further, the zoom imaging unit 2 includes an image pickup device with 1/7.4 inches and 640×480 pixels (330,000 pixels) as an image pickup device. Thus, the imaging range (field of view) of the wide-angle imaging unit 1 is 16 times the imaging range of the zoom imaging unit 2.

The zoom imaging unit 2 is mounted rotatably to the twin-lens camera 100. Specifically, the zoom imaging unit 2 is mounted to the twin-lens camera 100 through the two-axis spherical actuator 3. The zoom imaging unit 2 is thereby rotatable vertically and horizontally with respect to the twin-lens camera 100. The rotating range of the zoom imaging unit 2 is 70 degrees (π/180×70 rad) each in the vertical and horizontal directions of the twin-lens camera 100.

The two-axis spherical actuator 3 rotates the zoom imaging unit 2 so as to change the imaging range of the zoom imaging unit 2. Specifically, the two-axis spherical actuator 3 has a structure that drives a goniostage by a motor such as a stepping motor or a direct-current (DC) motor (not shown). The zoom imaging unit 2 is connected to the two-axis spherical actuator 3. The goniostage is rotatable vertically and horizontally with respect to the twin-lens camera 100. If a stepping motor is used, it is possible to easily obtain a rotation angle of the zoom imaging unit 2 based on a driving pulse that is input to the stepping motor. In other words, it is possible to obtain optical axis information of the zoom imaging unit 2. It is therefore preferred to use the stepping motor. In the case of using a DC motor, optical axis information of the zoom imaging unit 2 can be obtained based on detection information of a mounted encoder.

The controller 4 controls the operation of the two-axis spherical actuator 3. Specifically, the two-axis spherical actuator 3 rotates the zoom imaging unit 2 mounted on the goniostage under control of the controller 4.

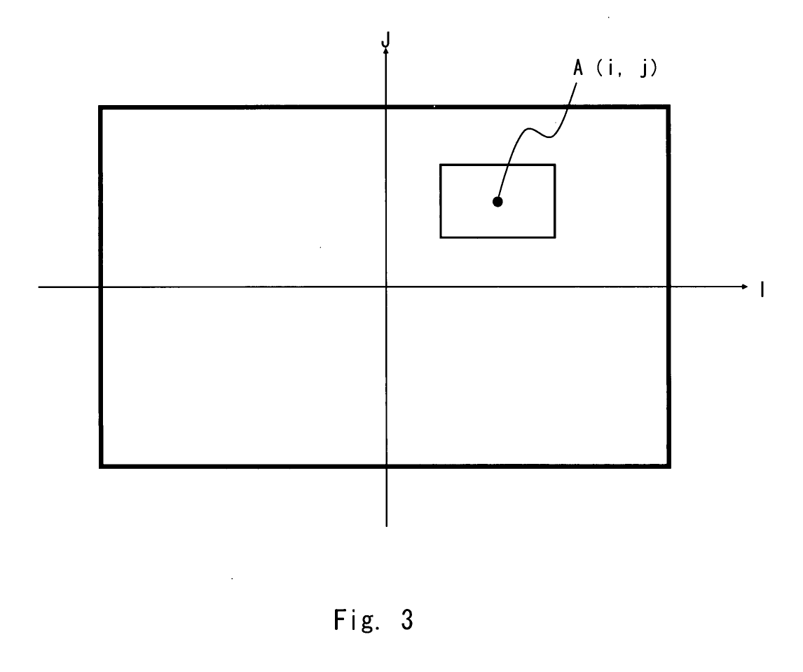

FIG. 3 shows a relationship between the imaging range of the wide-angle imaging unit 1 and the imaging range of the zoom imaging unit 2. In FIG. 3, a range defined by a heavy full line is the imaging range of the wide-angle imaging unit 1, and a range defined by a thin full line is the imaging range of the zoom imaging unit 2.

Referring to FIG. 3, a point of intersection of a wide-angle image captured by the wide-angle imaging unit 1 and the optical axis of the wide-angle imaging unit 1 (a center of the imaging range of the wide-angle imaging unit 1) is a point of origin, and the horizontal axis is called the I axis, and the vertical axis is called the J axis. The coordinates of a center A of the imaging range of the zoom imaging unit 2 are represented as (i, j). The coordinates are stored in the memory 5 as optical axis information of the zoom imaging unit 2. The controller 4 can calculate a rotation angle necessary for the zoom imaging unit 2 to capture an image in a given position of the wide-angle image by associating the coordinates in the imaging range of the wide-angle imaging unit 1 and the rotation angle of the zoom imaging unit 2 in advance. In other words, the coordinates in the wide-angle image serve as position information, and the controller 4 can calculate the rotation angle of the zoom imaging unit 2 based on the position information.

The memory 5 stores optical axis information of the zoom imaging unit 2.

Further, the memory 5 stores a wide-angle image that is captured by the wide-angle imaging unit 1. The memory 5 stores a wide-angle image in which a viewing angle per pixel is substantially equalized to that of a magnified image on which mosaicing is performed by an image comparison unit 72, and a partial image which is acquired by extracting a part of the wide-angle image.

Furthermore, the memory 5 stores a magnified image that is captured by the zoom imaging unit 2. The memory 5 stores a magnified image on which mosaicing is performed by the image comparison unit 72.

The memory 5 stores the number of pieces where the tone coincides between the partial image and the magnified image compared by the image comparison unit 72 (i.e. the degree of agreement). The memory 5 stores coordinate information of the compared partial image.

The interface 6 is a connection unit that connects the signal processing unit 7 of the twin-lens camera 100 with an external device that is connected to the twin-lens camera 100. For example, the interface 6 connects the twin-lens camera 100 with an input unit such as a keyboard (not shown), a display unit such as a liquid crystal display (LCD) (not shown) or the like. Recognition information, various kinds of commands and so on are input from the input unit to the signal processing unit 7 of the twin-lens camera 100 through the interface 6. Further, image data is input from the signal processing unit 7 of the twin-lens camera 100 to the display unit through the interface 6.

The signal processing unit 7 includes a field programmable gate array (FPGA). The signal processing unit 7 stores various kinds of programs for controlling the components of the twin-lens camera 100. The signal processing unit 7 controls the components of the twin-lens camera 100 by executing such programs. The signal processing unit 7 may be composed of a large-scale integration (LSI) or the like. In the case where the signal processing unit 7 is composed of a FPGA or the like, the programs stored in the signal processing unit 7 can be rewritten.

Referring to FIG. 2, the signal processing unit 7 includes an imaging control unit 71, an image comparison unit 72, an optical axis information update unit 73, an actuator control unit 74 (drive control unit) and so on.

The imaging control unit 71 stores a wide-angle image captured by the wide-angle imaging unit 1 into the memory 5. The imaging control unit 71 also stores a magnified image captured by the zoom imaging unit 2 into the memory 5.

The image comparison unit 72 performs mosaicing of the wide-angle image and the magnified image read from the memory and substantially equalizes a viewing angle per pixel to each other. In this embodiment, in order to reduce the image data size and shorten the processing time, the wide-angle image is mosaiced into 80×60 pixels, and the magnified image is mosaiced into 20×15 pixels. The ratio of the wide-angle image and the magnified image thereby becomes the original 16:1, and a viewing angle per pixel is substantially equalized.

Then, the image comparison unit 72 extracts a part of the mosaiced wide-angle image as a partial image. Specifically, the image comparison unit 72 extracts a partial image with 20×15 pixels from the mosaiced wide-angle image so as to compare the agreement in tone in each pixel with the mosaiced magnified image.

The image comparison unit 72 then compares the extracted partial image and the mosaiced magnified image and stores the number of pieces where the tone (luminance) is substantially the same in the corresponding pixels into the memory 5. The image comparison unit 72 further stores coordinate information of the partial image compared with the mosaiced magnified image into the memory 5.

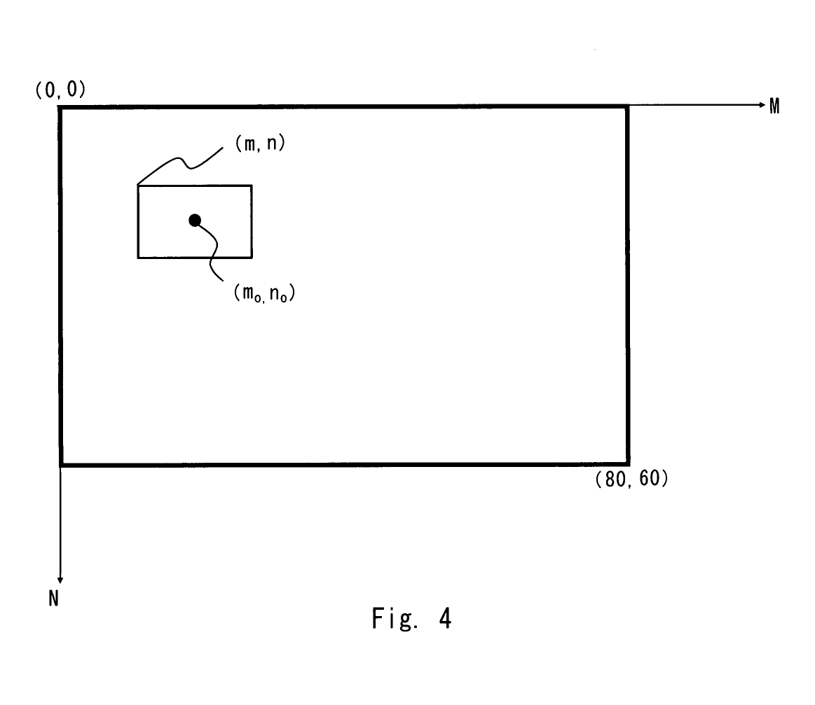

FIG. 4 shows coordinate information of a partial image. Referring to FIG. 4, a point at the upper left corner of a wide-angle image is a point of origin, and the horizontal axis is called the M axis, and the vertical axis is called the N axis. In this case, coordinates at the upper left corner of the partial image is represented as (m, n), and the coordinates are given as the coordinate information of the partial image. The coordinates are represented in units of one pixel.

Specifically, the image comparison unit 72 extracts the partial image in each coordinates in the wide-angle image with 80×60 pixels. The image comparison unit 72 then compares the partial image with the mosaiced magnified image and stores the degree of agreement in tone and the coordinate information of the partial image into the memory 5. At this time, the degree of agreement in tone for each partial image is stored together with the coordinate information of the partial image in each address of the memory 5. The address of the memory 5 and the coordinate information of the partial image are thereby associated with each other.

The optical axis information update unit 73 reads the degree of agreement in tone in pixels between the partial image and the mosaiced magnified image from each address of the memory 5. The optical axis information update unit 73 then obtains the coordinate information of the partial image having the maximum value of the degree of agreement. Because the address of the memory 5 and the coordinate information of the partial image are associated with each other, the coordinate information of the partial image can be obtained easily.

Based on the coordinate information of the partial image, the optical axis information update unit 73 updates (corrects) the optical axis information of the zoom imaging unit 2. Specifically, the optical axis information update unit 73 calculates the center coordinates (m₀, n₀) of the partial image. The optical axis information update unit 73 then makes the center coordinates (m₀, n₀) of the partial image correspond to the coordinate system shown in FIG. 3. Stated differently, the optical axis information update unit 73 derives the center coordinates (i₀, j₀) of the partial image in the coordinate system shown in FIG. 3. The center coordinates (i₀, j₀) of the partial image indicate the center coordinates of the magnified image that is actually captured by the zoom imaging unit 2. Thus, the optical axis information update unit 73 outputs the center coordinates (i₀, j₀) of the partial image as the optical axis information of the zoom imaging unit 2 to the memory 5 and thereby updates the prestored optical axis information of the zoom imaging unit 2. In this configuration, even when a loss of synchronization occurs in a stepping motor for driving the zoom imaging unit 2 and displacement exists in the optical axis information of the zoom imaging unit 2, for example, it is possible to easily correct the displacement. Further, because a sensor or the like is not necessary, it is possible to correct the displacement of the optical axis information of the zoom imaging unit 2 at low costs. Furthermore, wiring or the like can be eliminated, which simplifies the configuration.

The actuator control unit 74 controls the two-axis spherical actuator 3. Specifically, the actuator control unit 74 inputs a control signal for rotating the zoom imaging unit 2 to the controller 4, so that the zoom imaging unit 2 images a desired area. In response to the control signal, the controller 4 derives an angle of rotating the zoom imaging unit 2 (i.e. a rotation angle). The controller 4 then rotates the goniostage by the derived angle. The zoom imaging unit 2 is thereby rotated.

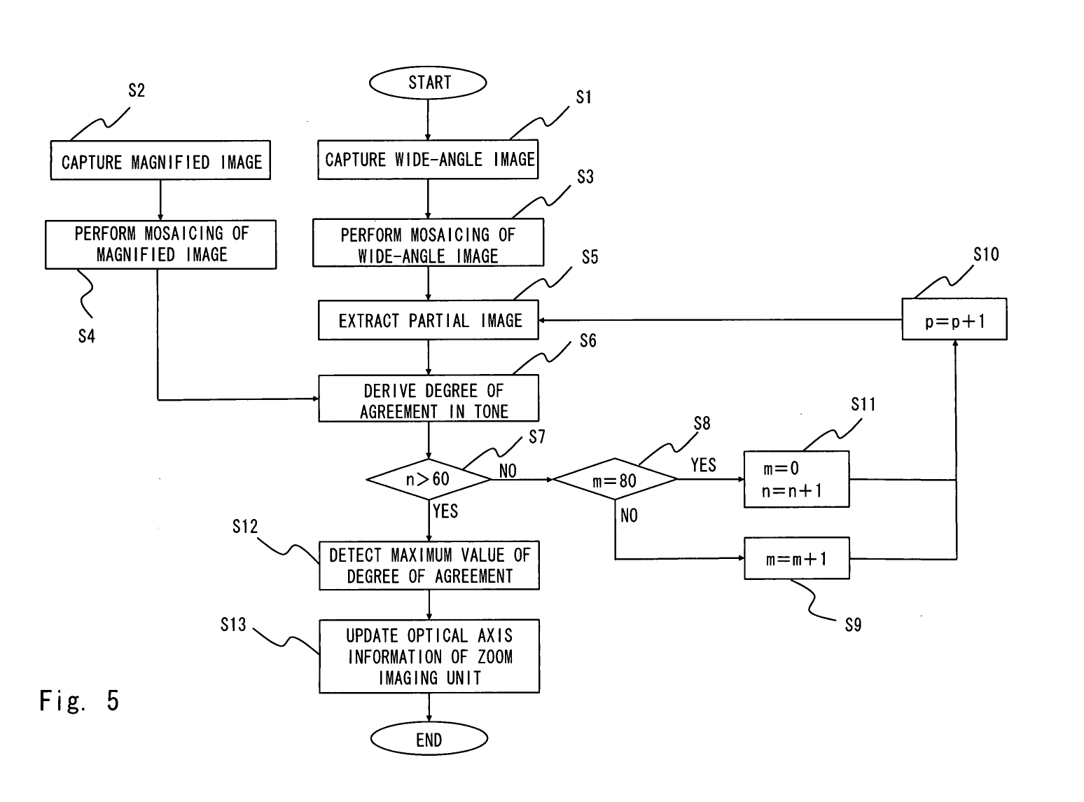

Hereinafter, an optical axis correction method of the twin-lens camera 100 according to the embodiment is described hereinafter with reference to the flowchart shown in FIG. 5. In FIG. 5, m and n indicate coordinate information of a partial image, and p indicates an address of the memory 5. The values of m, n, p are natural numbers including zero.

First, the imaging control unit 71 stores a wide-angle image (640×480 pixels) that is captured by the wide-angle imaging unit 1 into the memory 5 (step S1). The imaging control unit 71 also stores a magnified image (640×480 pixels) that is captured by the zoom imaging unit 2 into the memory 5 (step S2).

Next, the image comparison unit 72 reads the wide-angle image from the memory 5. The image comparison unit 72 performs mosaicing of the wide-angle image and stores the mosaiced wide-angle image into the memory 5 (step S3). The mosaiced wide-angle image has 80×60 pixels. The image comparison unit 72 also reads the magnified image from the memory 5. The image comparison unit 72 performs mosaicing of the magnified image in such a way that a viewing angle per pixel of the magnified image is substantially equal to that of the mosaiced wide-angle image. The image comparison unit 72 stores the mosaiced magnified image into the memory 5 (step S4). The mosaiced magnified image has 20×15 pixels.

Then, the image comparison unit 72 reads the mosaiced wide-angle image from the memory 5. The image comparison unit 72 extracts a partial image (20×15 pixels) from the wide-angle image and stores the partial image into the memory (step S5). The coordinate information of the partial image is (0, 0).

Further, the image comparison unit 72 reads the mosaiced magnified image and the partial image with the coordinate information (0, 0) from the memory 5. The image comparison unit 72 compares the mosaiced magnified image and the partial image and derives the degree of agreement in tone in the respective pixels. The image comparison unit 72 then stores the degree of agreement and the coordinate information (0, 0) of the partial image into an address 0 of the memory 5 (step S6).

After that, the image comparison unit 72 determines whether the coordinate information n of the partial image is larger than 60 or not (step S7). If the image comparison unit 72 determines that the coordinate information n of the partial image is smaller than 60, it further determines whether the coordinate information m of the partial image is equal to 80 or not (step S8). If the image comparison unit 72 determines that the coordinate information m of the partial image is not equal to 80, it adds 1 to the coordinate information m of the partial image (step S9). The image comparison unit 72 then adds 1 to the address p of the memory 5 (step S10) and returns to the step S5 to extract the partial image. The image comparison unit 72 then extracts a partial image with the coordinate information (1, 0) and compares the partial image and the mosaiced magnified image. Although m=m+1 and p=p+1 are shown in FIG. 5 for the sake of convenience, the values of m and p in the left-hand side are values after adding 1.

As described above, the image comparison unit 72 compares the partial image and the mosaiced magnified image by shifting the partial image to be extracted pixel by pixel in the m-axis direction, and thereby derives the degree of agreement in tone in their pixels. In each comparison, the image comparison unit 72 stores the degree of agreement together with the coordinate information of the partial image into each address of the memory 5.

On the other hand, if the image comparison unit 72 determines in the step S8 that the coordinate information m of the partial image is equal to 80, it sets the coordinate information m of the partial image to 0. The image comparison unit 72 then adds 1 to the coordinate information n of the partial image (step S11). Although n=n+1 is shown in FIG. 5 for the sake of convenience, the value of n in the left-hand side is a value after adding 1. The image comparison unit 72 then adds 1 to the address p of the memory 5 (step S10). Thus, the image comparison unit 72 extracts a partial image with the coordinate information (0, 1) and compares the partial image and the mosaiced magnified image. Further, as described above, the image comparison unit 72 compares the partial image and the mosaiced magnified image by shifting the partial image to be extracted pixel by pixel in the m-axis direction, and thereby derives the degree of agreement in tone in their pixels. In each comparison, the image comparison unit 72 stores the degree of agreement together with the coordinate information of the partial image into each address of the memory 5.

In this manner, scanning in the m-axis direction that compares the partial image and the mosaiced magnified image is repeated in the n-axis direction. If the image comparison unit 72 determines in the step S7 that the coordinate information n of the partial image is larger than 60, it outputs a signal indicating the end of comparison processing to the optical axis information update unit 73. This is because if the coordinate information n of the partial image is larger than 60, it means that the comparison with the mosaiced magnified image is completed in the entire area of the wide-angle image.

The optical axis information update unit 73 reads the degree of agreement from each address of the memory 5. The optical axis information update unit 73 reads the coordinate information of the partial image having the maximum value of the degree of agreement (step S12). The optical axis information update unit 73 then calculates the center coordinates (m₀, n₀) of the relevant partial image. The optical axis information update unit 73 then makes the center coordinates (m₀, n₀) of the partial image correspond to the coordinate system shown in FIG. 3. Specifically, the optical axis information update unit 73 calculates the center coordinates (i₀, j₀) of the partial image in the coordinate system shown in FIG. 3. Then, the optical axis information update unit 73 outputs the center coordinates (i₀, j₀) of the partial image as the optical axis information of the zoom imaging unit 2 to the memory 5 and thereby updates the prestored optical axis information of the zoom imaging unit 2 (step S13). A series of update processing thereby ends. In this process, even when a loss of synchronization occurs in a stepping motor for driving the zoom imaging unit 2 and displacement exists in the optical axis information of the zoom imaging unit 2, it is possible to easily correct the displacement. Further, because a sensor or the like is not necessary, it is possible to correct the displacement of the optical axis information of the zoom imaging unit 2 at low costs. Furthermore, wiring or the like can be eliminated, which simplifies the configuration.

In this embodiment, imaging conditions are assumed in which the tone of the partial image and the mosaiced magnified image in pixels is relatively high. However, if the imaging range is too dark or too bright, the image is uniform in the entire imaging range, which causes the correspondence with the optical axis information of the zoom imaging unit 2 to be unclear. Therefore, it is preferred that if a difference between the maximum value of the degree of agreement in tone in pixels of the partial image and the mosaiced magnified image and the second maximum value of the degree of agreement becomes equal to or larger than a threshold, the optical axis information update unit 73 updates the optical axis information of the zoom imaging unit 2 based on the coordinate information of the partial image having the maximum value. For example, the optical axis information update unit 73 updates the optical axis information of the zoom imaging unit 2 only when a difference between the maximum value of the degree of agreement in tone in pixels of the partial image and the mosaiced magnified image and the second maximum value of the degree of agreement is equal to or larger than 150 pixels (which is half of 20×15 pixels). This prevents an increase in displacement of the optical axis information of the zoom imaging unit 2 due to inappropriate update of the optical axis information of the zoom imaging unit 2.

Although the optical axis information of the zoom imaging unit 2 is updated based on the coordinate information of the partial image with the maximum value on the condition that there is one maximum value of the degree of agreement in tone in pixels of the partial image and the mosaiced magnified image in this embodiment, the present invention is not limited thereto. In some imaging conditions, a plurality of maximum values can exist. In such a case, the optical axis information update unit 73 does not update the optical axis information of the zoom imaging unit 2. This prevents an increase in displacement of the optical axis information of the zoom imaging unit 2 due to inappropriate update of the optical axis information of the zoom imaging unit 2.

In this embodiment, there is no particular mention to timing of performing the above-described update processing. It is not necessary to perform the update processing each time capturing the magnified image, and the update processing may be performed at regular time intervals. For example, the update processing is performed at every ten seconds.

Although the comparison between the partial image and the mosaiced magnified image is made from the coordinates (0, 0) to (80, 60) in this embodiment, the present invention is not limited thereto. The comparison between the partial image and the mosaiced magnified image may be made from the coordinates (0, 0) to (60, 45) at minimum.

### Second Embodiment

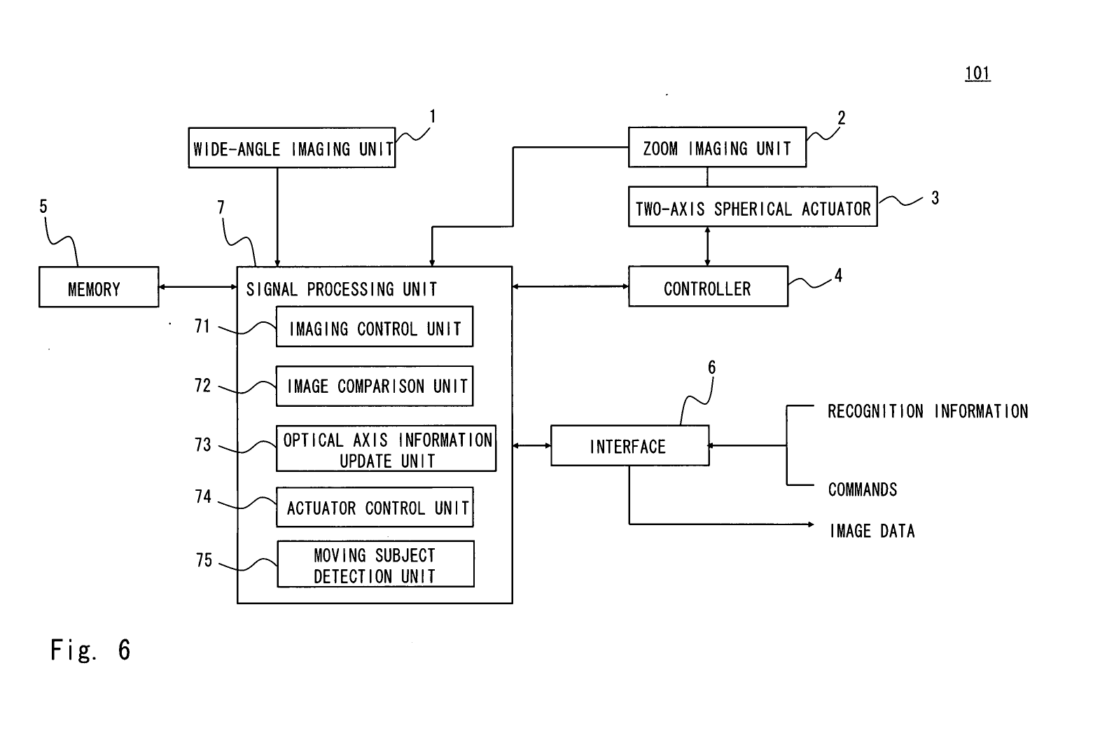

An imaging apparatus (twin-lens camera) 101 according to a second embodiment of the present invention is described hereinafter. The twin-lens camera 101 according to the embodiment includes a moving subject detection unit 75 as shown in FIG. 6. The other elements are the same as those described in the first embodiment and not redundantly described.

The moving subject detection unit 75 detects a moving subject part from a change in a wide-angle image captured by the wide-angle imaging unit 1, for example. The moving subject detection unit 75 causes the actuator control unit 74 to generate a control signal of the two-axis spherical actuator 3 so as to track and image the moving subject by the zoom imaging unit 2 based on the detection result. Specifically, the moving subject detection unit 75 derives coordinate information of a range R in the wide-angle image from which the moving subject is detected in the coordinate system shown in FIG. 3, for example. The moving subject detection unit 75 then causes the actuator control unit 74 to generate a control signal of the two-axis spherical actuator 3 based on the coordinate information of the range R so as to image the range R by the zoom imaging unit 2. The actuator control unit 74 thereby generates the control signal. The controller 4 controls the two-axis spherical actuator 3 based on the generated control signal. The moving subject detection unit 75, however, is not limited to have the above-described configuration, and it may have a known configuration that detects and tracks a moving subject as disclosed in Japanese Unexamined Patent Application Publication No. 2004-355601, for example.

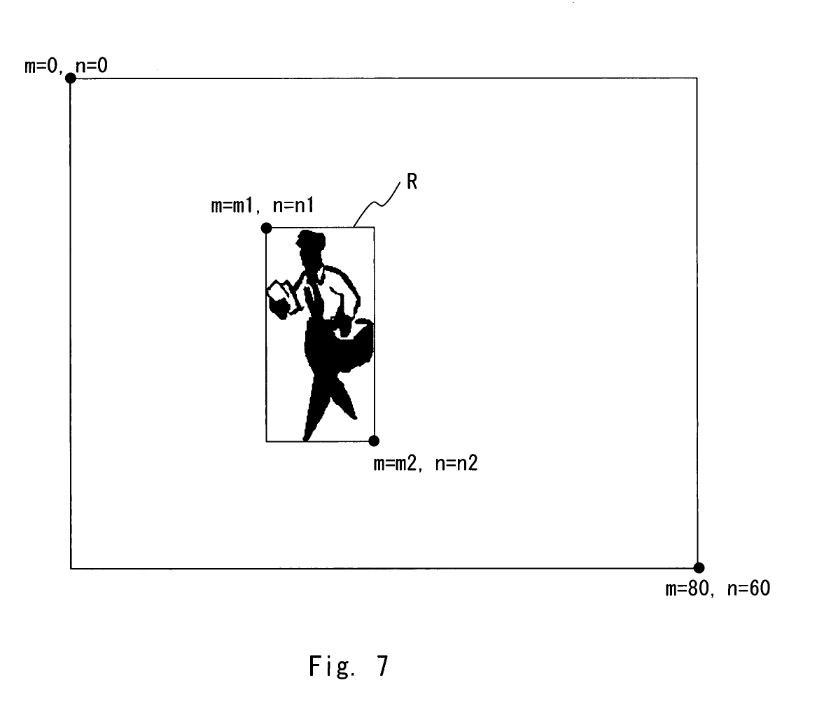

The range R thus corresponds to the imaging range of the zoom imaging unit 2. Therefore, the comparison with the magnified image can be made only in the area of the range R rather than in the whole area of the wide-angle image as in the first embodiment described above. Thus, the image comparison unit 72 derives coordinates (m1, n1) at the upper left corner and coordinates (m2, n2) at the lower right corner of the range R as shown in FIG. 7 and compares the partial image of the wide-angle image and the magnified image within this area.

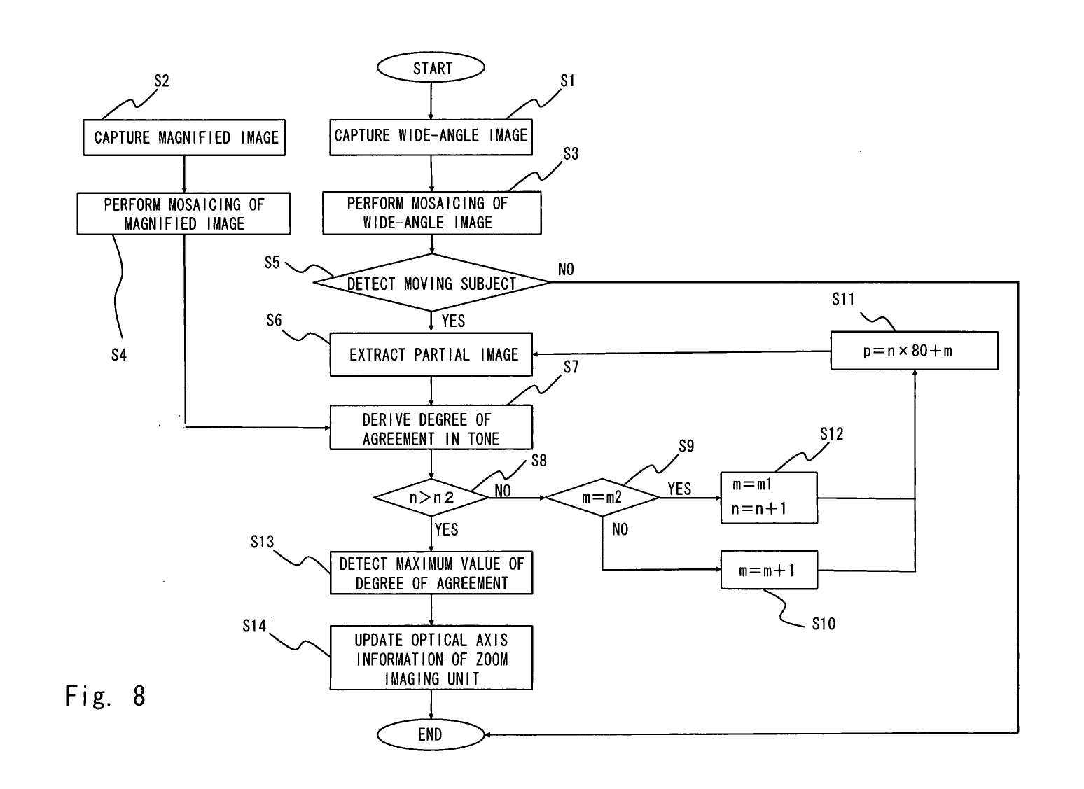

Specifically, referring to FIG. 8, the process in the steps S1 to S4 are the same as that in the first embodiment described above. The image comparison unit 72 then determines whether a moving subject part is detected in the mosaiced wide-angle image (step S5). If a signal indicating detection of a moving subject is input from the moving subject, detection unit 75 to the image comparison unit 72, the image comparison unit 72 determines that a moving subject part is detected and reads coordinate information of the range R in the wide-angle image from the memory 5. The image comparison unit 72 then converts the coordinate information into coordinates in the coordinate system shown in FIG. 4 and thereby derives coordinates (m1, n1) at the upper left corner and coordinates (m2, n2) at the lower right corner of the range R as shown in FIG. 7.

Next, the image comparison unit 72 reads the mosaiced wide-angle image from the memory 5. The image comparison unit 72 then extracts a partial image (20×15 pixels) from the wide-angle image and stores the partial image into the memory 5 (step S6). The coordinate information of the partial image is (m1, n1).

Then, the image comparison unit 72 reads the mosaiced magnified image and the partial image with the coordinate information (m1, n1) from the memory 5. The image comparison unit 72 compares the mosaiced magnified image with the partial image and derives the degree of agreement in tone in the respective pixels. The image comparison unit 72 then stores the degree of agreement and the coordinate information (m1, n1) of the partial image into an address n1×80+m1 of the memory 5 (step S7).

After that, the image comparison unit 72 determines whether the coordinate information n of the partial image is larger than n2 or not (step S8). If the image comparison unit 72 determines that the coordinate information n of the partial image is smaller than n2, it further determines whether the coordinate information m of the partial image is equal to m2 or not (step S9). If the image comparison unit 72 determines that the coordinate information m of the partial image is not equal to m2, it adds 1 to the coordinate information m of the partial image (step S10). The image comparison unit 72 then sets the address p of the memory 5 to n×80+m (step S11) and returns to the step S6 to extract the partial image. The image comparison unit 72 then extracts a partial image with the coordinate information (m1+1, n1) and compares the partial image and the mosaiced magnified image. Although m=m+1 is shown in FIG. 8 for the sake of convenience, the value of m in the left-hand side is a value after adding 1. Further, although p=n×80+m is shown in FIG. 8 for the sake of convenience, the values of m in this case is the value of m in the left-hand side in the step S10.

As described above, the image comparison unit 72 shifts the partial image to be extracted pixel by pixel in them-axis direction. The image comparison unit 72 compares the partial image with the mosaiced magnified image and thereby derives the degree of agreement in tone in their pixels. In each comparison, the image comparison unit 72 stores the degree of agreement together with the coordinate information of the partial image into each address of the memory 5.

On the other hand, if the image comparison unit 72 determines in the step S9 that the coordinate information m of the partial image is equal to m2, it sets the coordinate information m of the partial image to m1 and adds 1 to the coordinate information n of the partial image (step S12). The image comparison unit 72 then sets the address p of the memory 5 to n×80+m (step S11) and returns to the step S6 to extract the partial image. The image comparison unit 72 then extracts a partial image with the coordinate information (m1, n1+1) and compares the partial image and the mosaiced magnified image. Further, as described above, the image comparison unit 72 shifts the partial image to be extracted pixel by pixel in the m-axis direction. The image comparison unit 72 compares the partial image with the mosaiced magnified image and thereby derives the degree of agreement in tone in their pixels. In each comparison, the image comparison unit 72 stores the degree of agreement together with the coordinate information of the partial image into each address of the memory 5. Although n=n+1 is shown in FIG. 8 for the sake of convenience, the value of n in the left-hand side is a value after adding 1. Further, although p=n×80+m is shown in FIG. 8 for the sake of convenience, the values of n and m in this case are the values of n and m in the left-hand side in the step S12.

In this manner, scanning in the m-axis direction that compares the partial image and the mosaiced magnified image is repeated in the n-axis direction. If the image comparison unit 72 determines in the step S8 that the coordinate information n of the partial image is larger than n2, it outputs a signal indicating the end of comparison processing to the optical axis information update unit 73. This is because if the coordinate information n of the partial image is larger than n2, it means that the comparison with the mosaiced magnified image is completed in the entire area of the range R in the wide-angle image.

The optical axis information update unit 73 reads the degree of agreement from each address of the memory 5. The optical axis information update unit 73 reads the coordinate information of the partial image having the maximum value of the degree of agreement (step S13). The optical axis information update unit 73 then calculates the center coordinates (m₀, n₀) of the partial image. The optical axis information update unit 73 then makes the center coordinates (m₀, n₀) of the partial image correspond to the coordinate system shown in FIG. 3. Specifically, the optical axis information update unit 73 calculates the center coordinates (i₀, j₀) of the partial image in the coordinate system shown in FIG. 3. Then, the optical axis information update unit 73 outputs the center coordinates (i₀, j₀) of the partial image as the optical axis information of the zoom imaging unit 2 to the memory 5 and thereby updates the prestored optical axis information of the zoom imaging unit 2 (step S14). A series of update processing thereby ends. Because the comparison with the magnified image is made only in the range R of the wide-angle image as described above, it is possible to significantly reduce the time for update processing.

If the image comparison unit 72 determines in the step S5 that a moving subject part is not detected, update processing ends. This is because the zoom imaging unit 2 is often used for imaging a moving subject, and it is likely that no image is captured by the zoom imaging unit 2 when there is no moving subject.

Although the comparison between the partial image and the mosaiced magnified image is made from the coordinates (m1, n1) to (m2, n2) in this embodiment, the present invention is not limited thereto. The comparison between the partial image and the mosaiced magnified image may be made from the coordinates (m1, n1) to (m2−20, n2−15) at minimum.

### Third Embodiment

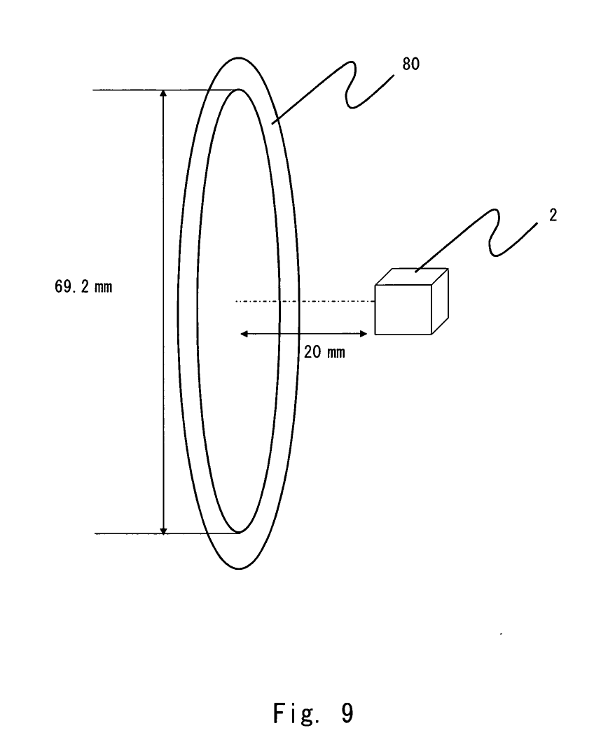

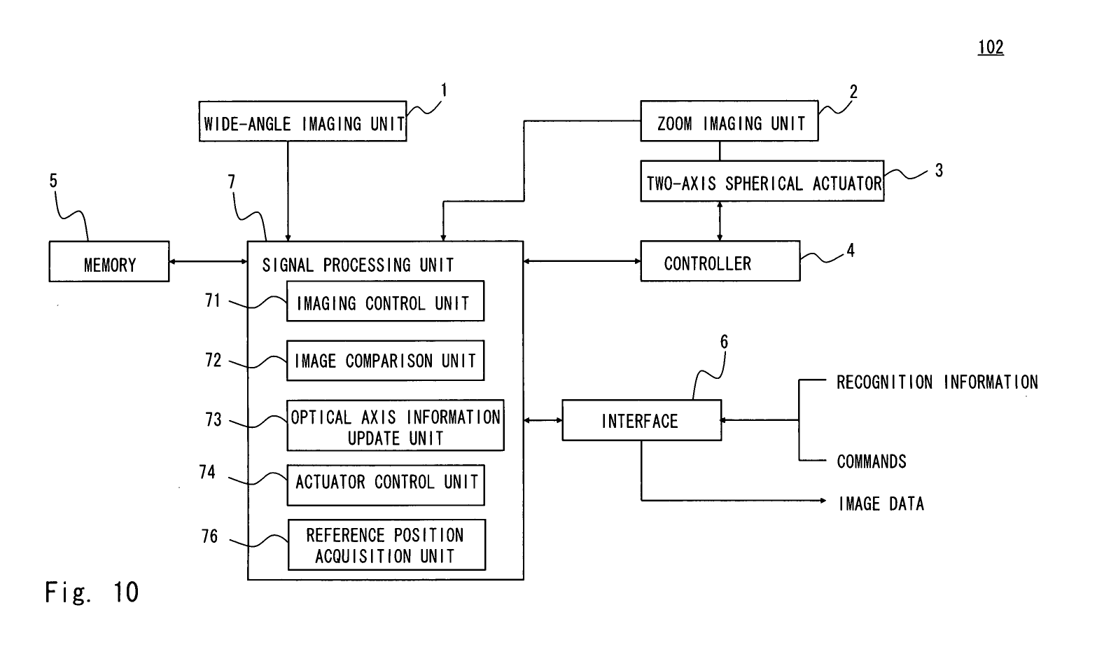

An imaging apparatus (twin-lens camera) 102 according to a third embodiment of the present invention is described hereinafter. The twin-lens camera 102 according to the embodiment includes a light shielding element 80 as shown in FIG. 9. Further, as shown in FIG. 10, the twin-lens camera 102 according to the embodiment includes a reference position acquisition unit 76 that acquires a reference position of the zoom imaging unit 2 based on coordinate information of the light shielding element 80 appearing in a magnified image captured by the zoom imaging unit 2. The other elements are the same as those described in the first embodiment and not redundantly described.

In this embodiment, the light shielding element 80 having an opening with a diameter of 69.2 mm is placed 20 mm away from the front of the center of the zoom imaging unit 2. A specific numerical value is not limited thereto and may be set as appropriate.

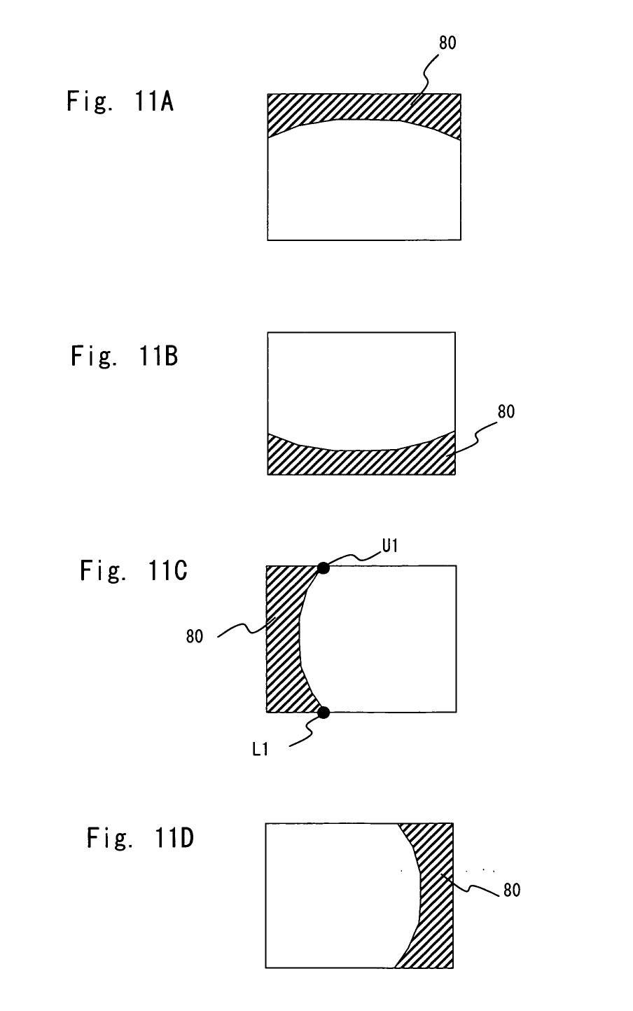

If the zoom imaging unit 2 is driven to a limit position of a movable range, the end of the light shielding element 80 appears in a magnified image as shown in FIGS. 11A to 11D depending on the direction of the optical axis of the zoom imaging unit 2. FIG. 11A shows a magnified image when the zoom imaging unit 2 is driven to an upper limit position. FIG. 11B shows a magnified image when the zoom imaging unit 2 is driven to a lower limit position. FIG. 11C shows a magnified image when the zoom imaging unit 2 is driven to a left limit position. FIG. 11D shows a magnified image when the zoom imaging unit 2 is driven to a right limit position.

The twin-lens camera 102 according to the embodiment derives a reference position of the zoom imaging unit 2 with respect to camera housing by using the light shielding element 80 appearing in the magnified image in this manner.

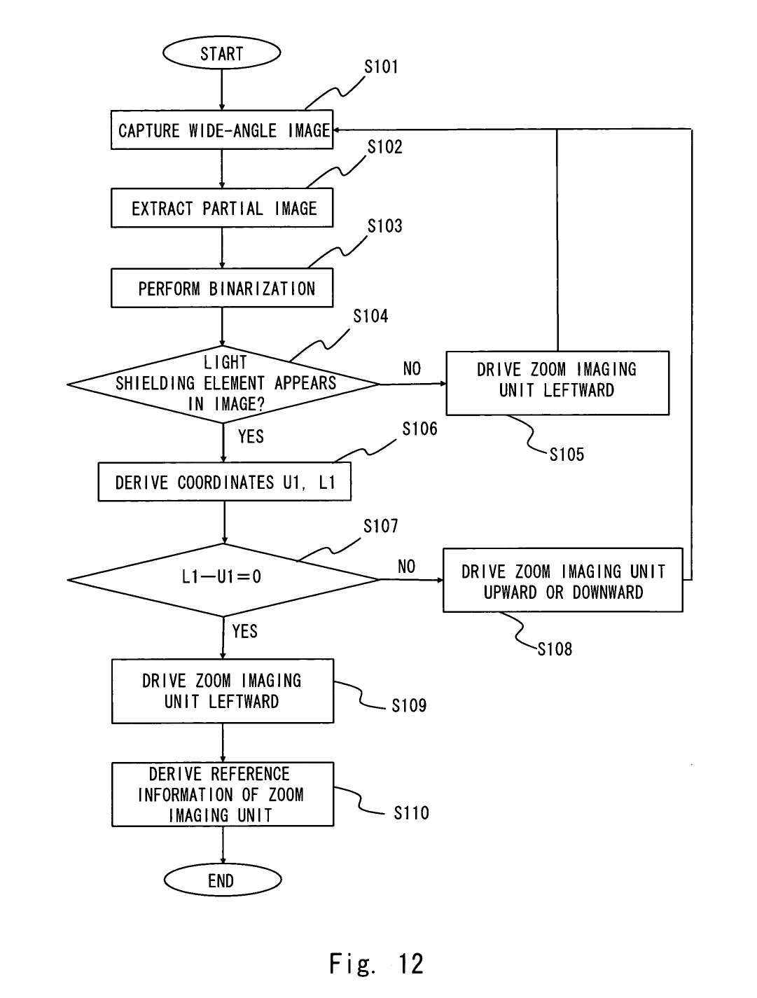

Referring to FIG. 12, the zoom imaging unit 2 first captures a magnified image. The imaging control unit 71 stores the captured magnified image into the memory 5 (step S101). Next, the imaging control unit 71 reads the magnified image from the memory 5. The imaging control unit 71 extracts a partial image at the center from the magnified image and stores it into the memory 5 (step S102). The extracted partial image has 480×480 pixels, for example. The imaging control unit 71 reads the partial image from the memory 5 and performs binarization. The imaging control unit 71 then stores the binarized partial image into the memory 5 (step S103).

Then, the reference position acquisition unit 76 reads the binarized partial image from the memory 5. The reference position acquisition unit 76 determines whether the light shielding element 80 appears at the upper end and the lower end on the left end side of the partial image (step S104). Specifically, in this embodiment, the reference position acquisition unit 76 determines whether the binarized partial image is close to the image shown in FIG. 11C. If the reference position acquisition unit 76 determines that the light shielding element 80 does not appear at the upper end and the lower end on the left end side of the partial image, it causes the actuator control unit 74 to generate a control signal of the two-axis spherical actuator 3 so as to drive the zoom imaging unit 2 to the left limit position. The actuator control unit 74 thereby generates the control signal. The controller 4 controls the two-axis spherical actuator 3 based on the generated control signal (step S105). The process then returns to the step S101 and repeats the steps S101 to 5104.

On the other hand, if the reference position acquisition unit 76 determines that the light shielding element 80 appears at the upper end and the lower end on the left end side of the binarized partial image, it derives coordinates (U1) at the upper end and coordinates (L1) at the lower end (step S106; FIG. 11C). In this case, coordinates in the horizontal direction of the partial image are derived.

If the value of L1−U1 is zero, it can be determined that the zoom imaging unit 2 is located at the center in the vertical direction. Thus, the reference position acquisition unit 76 calculates the value of L1−U1 (step S107). If the reference position acquisition unit 76 determines that the value of L1−U1 is not equal to zero, it causes the actuator control unit 74 to generate a control signal of the two-axis spherical actuator 3 so as to move the zoom imaging unit 2 in the vertical direction. The actuator control unit 74 thereby generates the control signal. The controller 4 controls the two-axis spherical actuator 3 based on the generated control signal (step 5108). Specifically, if the value of L1−U1 is a positive value, the reference position acquisition unit 76 determines that the zoom imaging unit 2 is oriented downward. The reference position acquisition unit 76 thereby causes the actuator control unit 74 to generate the control signal so as to move the zoom imaging unit 2 upward. On the other hand, if the value of L1−U1 is a negative value, the reference position acquisition unit 76 determines that the zoom imaging unit 2 is oriented upward. The reference position acquisition unit 76 thereby causes the actuator control unit 74 to generate the control signal so as to move the zoom imaging unit 2 downward. It is preferred that the actuator control unit 74 derives the amount of movement of the zoom imaging unit 2 in the vertical direction from the value of L1−U1 by associating the value of L1−U1 and the amount of movement of the zoom imaging unit 2 in the vertical direction in advance. Further, if the value of L1−U1 is not equal to zero, the actuator control unit 74 may move the zoom imaging unit 2 in the vertical direction by a minute amount of movement that is set in advance. The process then returns to the step S101 and repeats the steps S101 to S107.

On the other hand, if the reference position acquisition unit 76 determines that the value of L1−U1 is equal to zero, it causes the actuator control unit 74 to generate a control signal of the two-axis spherical actuator 3 so as to move the zoom imaging unit 2 to the left limit position (step S109). The actuator control unit 74 thereby generates the control signal. The controller 4 controls the two-axis spherical actuator 3 based on the generated control signal. At this time, the zoom imaging unit 2 is located at the center in the vertical direction and located at the left end in the horizontal direction. The reference position acquisition unit 76 determines such a position of the zoom imaging unit 2 as a reference position and stores the center coordinates of the partial image at the reference position into the memory 5 as the direction of the optical axis of the zoom imaging unit 2 when turning on power of the twin-lens camera. In this manner, the reference position of the zoom imaging unit 2 with respect to camera housing can be easily derived by using the magnified image of the zoom imaging unit 2 and the light shielding element 80.

Under imaging conditions with no light, however, the reference position of the zoom imaging unit 2 cannot be derived in the above-described manner. In such a case, brightness at the front of the twin-lens camera may be detected in advance by the wide-angle imaging unit 1, and it may be determined whether to derive the reference position of the zoom imaging unit 2 based on the detection result. Alternatively, the direction of movement of the two-axis spherical actuator 3 when deriving the reference position of the zoom imaging unit 2 may be determined. Specifically, a range with high luminance is detected in a wide-angle image captured in advance, and the reference position of the zoom imaging unit 2 is derived within the range. More specifically, the reference position acquisition unit 76 reads a wide-angle image from the memory 5, detects a range with high luminance in the wide-angle image, and causes the actuator control unit 74 to generate a control signal so as to image the range by the zoom imaging unit 2. The actuator control unit 74 thereby generates the control signal. The controller 4 controls the two-axis spherical actuator 3 based on the generated control signal.

Although the position at the left end of the zoom imaging unit 2 is derived in this embodiment, the reference position of the zoom imaging unit 2 may be derived in substantially the same manner when deriving any of the positions at the right end, the upper end and the lower end.

The embodiment is described on the assumption of a drive limit position, which is a mechanical limit position, of the zoom imaging unit 2. However, if it is based on the assumption of a system limit position of the zoom imaging unit 2, the light shielding element can appear in the entire area of the partial image. In this case, the zoom imaging unit 2 is driven vertically and horizontally until the light shielding element appears at the upper end and the lower end on the left end side of the partial image.

Although the reference position of the zoom imaging unit 2 is derived based on a difference in the coordinates of the light shielding element 80 appearing in the image in this embodiment, the present invention is not limited thereto. Because the curvature of the light shielding element 80 appearing in the image is known, the reference position of the zoom imaging unit 2 may be derived directly from the coordinates of the light shielding element 80 appearing in the image.

Further, although the image comparison unit 72 and the optical axis information update unit 73 are included in this embodiment just like in the above-described first embodiment, they may be eliminated. In short, the embodiment is not limited in such a fashion as long as the reference position of the zoom imaging unit 2 can be derived when turning on power of the twin-lens camera.

### Fourth Embodiment

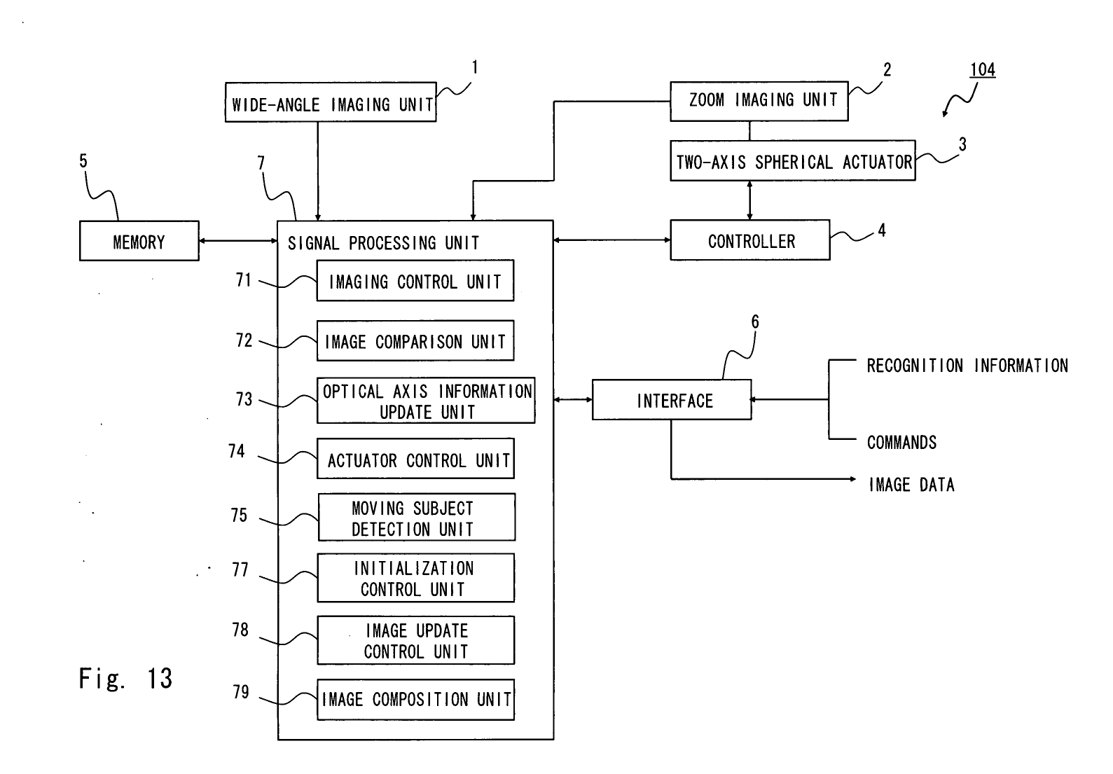

An imaging apparatus (twin-lens camera) 104 according to a fourth embodiment of the present invention is described hereinafter. The twin-lens camera 104 according to the embodiment is capable of improving the quality of an image captured by the wide-angle imaging unit 1 as shown in FIG. 13. The twin-lens camera 104 images the entire imaging range of the wide-angle imaging unit 1 by the zoom imaging unit 2 and combines images of the zoom imaging unit 2, thereby obtaining a high-quality wide-angle image.

For example, the imaging range of the wide-angle imaging unit 1 is set to be nine times (three times vertically and three times horizontally) the imaging range of the zoom imaging unit 2. When imaging the whole area of the imaging range of the wide-angle imaging unit 1 by the zoom imaging unit 2, the imaging range of the wide-angle imaging unit 1 is divided into nine zones, and the zoom imaging unit 2 images the respective divided ranges one by one.

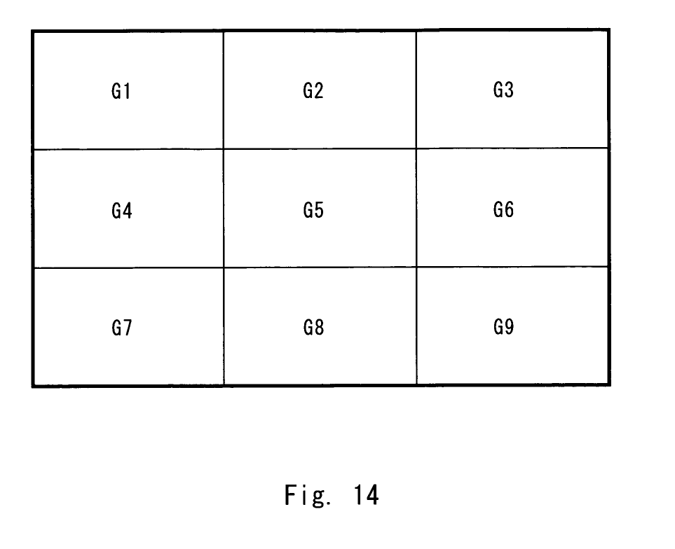

The nine imaging ranges obtained by dividing the imaging range of the wide-angle imaging unit 1 into nine zones are called G1 to G9 from the upper left to the lower right as shown in FIG. 14. Each of the imaging ranges G1 to G9 is detected by an image sensor of 640×480 pixels. Thus, the number of pixels of image data in the imaging ranges G1 to G9 is 640×480 pixels each. The image data in the imaging ranges G1 to G9 is stored respectively into given areas of the memory 5 as described later.

The signal processing unit 7 includes an initialization control unit 77, an image update control unit 78, an image composition unit 79 and so on, in addition to the elements of the signal processing unit 7 according to the second embodiment.

The initialization control unit 77 divides the whole area of the imaging range of the wide-angle imaging unit 1 into a plurality of imaging ranges and causes the two-axis spherical actuator 3 to rotate the zoom imaging unit 2, so that the zoom imaging unit 2 sequentially images the plurality of imaging ranges. Next, the initialization control unit 77 causes the memory 5 to store a plurality of image data captured by the zoom imaging unit 2 in association with position information of the image data. Specifically, the memory 5 stores image data of the imaging range G1 and position information G1 in association with each other. More specifically, the imaging ranges G1 to G9 and address of the memory 5 where image data of the imaging ranges G1 to G9 are to be stored are respectively associated in advance. For example, image data of the imaging range G1 is stored at addresses 1 to 640×480 of the memory 5. Likewise, image data of the imaging range G2 is stored at addresses 640×480+1 to 640×480×2 of the memory 5. Thus, the initialization control unit 77 stores image data into the address of the memory 5 associated in advance with position information (imaging range) of the image data, thereby storing the image data and the position information of the image data in association with each other in the memory 5.

The initialization control unit 77 divides the imaging range of the wide-angle imaging unit 1 into a plurality of imaging ranges based on the angle of view of the wide-angle imaging unit 1 and the angle of view of the zoom imaging unit 2.

The image update control unit 78 updates the image data stored in the memory 5 based on image data of an imaging range including a moving subject that is obtained when the zoom imaging unit 2 images the moving subject (which is referred to hereinafter as moving subject image data) and position information of the moving subject image data. Specifically, the image update control unit 78 updates the image data stored in the memory 5 by replacing image data having position information corresponding to the position information of the moving subject image data with the moving subject image data. More specifically, the image update control unit 78 calculates an address of the memory 5 at which moving subject image data is to be stored from the imaging range of the moving subject image data. Then, the image update control unit 78 replaces image data stored at the address with the moving subject image data. The image data in the memory 5 is thereby updated.

The image composition unit 79 combines a plurality of image data based on a plurality of image data with different imaging ranges stored in the memory 5 and position information of the image data and thereby creates image data over a wide range. Specifically, the image composition unit 79 determines an imaging range as position information from an address of the memory 5 and allocates image data stored at the address to the imaging range. The image data is thereby allocated to each imaging range, and image data over a wide range is created. More specifically, the image composition unit 79 allocates image data stored at addresses 1 to 640×480 of the memory 5 to the imaging range G1. Likewise, the image composition unit 79 allocates image data stored at addresses 640×480+1 to 640×480×2 of the memory 5 to the imaging range G2. In this manner, the image composition unit 79 allocates image data stored in the memory 5 to the imaging ranges G1 to G9 and thereby creates image data over a wide range.

In this manner, the zoom imaging unit 2 captures a plurality of image data in different imaging ranges with a higher magnification than the wide-angle imaging unit 1. Then, the image composition unit 79 combines the plurality of image data in different imaging ranges that are captured with a high magnification and creates image data over a wide range. Therefore, detailed wide-angle image data can be created by combining the plurality of image data obtained when the zoom imaging unit 2 images the imaging range of the wide-angle imaging unit 1 by dividing it into a plurality of ranges. The detailed wide-angle image data is image data in substantially the same range as the imaging range of the wide-angle imaging unit 1. Further, the detailed wide-angle image data is high quality because it is imaged by the zoom imaging unit 2 with a high magnification. The detailed wide-angle image data can be used instead of image data captured by the wide-angle imaging unit 1. It is thereby possible to prevent degradation of the quality of image data of the wide-angle imaging unit 1 caused by an increase in the angle of view of a lens of the wide-angle imaging unit 1. Further, this eliminates the need to use an image pickup device having a large number of pixels with an increase in the angle of view of a lens of the wide-angle imaging unit 1. It is thereby possible to prevent an increase in costs.

Initialization processing in the twin-lens camera 104 according to the embodiment is described hereinafter.

First, the initialization control unit 77 causes the two-axis spherical actuator 3 to rotate the zoom imaging unit 2 so as to image the imaging range G1 by the zoom imaging unit 2 and then stores the acquired image data into a G1 storage area of the memory 5. This processing is repeated in the same manner from the imaging range G2 to the imaging range G9, thereby obtaining a high-quality wide-angle image by the zoom imaging unit 2 over the imaging range of the wide-angle imaging unit 1.

Update processing of the memory 5 in the twin-lens camera 104 according to the embodiment is described hereinafter.

The moving subject detection unit 75 first analyzes image data captured by the wide-angle imaging unit 1. The moving subject detection unit 75 determines whether there is movement (whether there is a moving subject) in the image captured by the wide-angle imaging unit 1, and only if there is movement, performs the following processing. If the moving subject detection unit 75 determines that there is movement in the image, the actuator control unit 74 controls the imaging range of the zoom imaging unit 2 so as to image the moving subject detected by the moving subject detection unit 75. The zoom imaging unit 2 acquires image data of the imaging range including the moving subject detected by the moving subject detection unit 75. The image update control unit 78 updates the image data stored in the memory 5 based on moving subject image data and position information of the moving subject image data obtained by the moving subject detection unit 75. The process thereby ends.

It is thereby possible to track a moving subject and capture an image in the vicinity of the moving subject with a high magnification. It is thus possible to track a moving subject and performs detailed imaging.

The present invention is not limited to the above-described embodiments, and various changes may be made without departing from the scope of the invention. For example, although a comparison between a partial image and a mosaiced magnified image is made on the basis of coordinates at the upper left of the partial image extracted from a wide-angle image in the above-described embodiments, the comparison may be made on the basis of coordinates at any of the lower left, the upper right and the lower right, or any position, of the partial image. Further, the above-described image size is merely an example, and the image size is not limited thereto.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An imaging apparatus including a plurality of imaging units each having a lens and an image pickup device, at least one of the plurality of imaging units being a wide-angle imaging unit having a lens with a wider angle of view than another imaging unit, and at least one of the plurality of imaging units being a zoom imaging unit having a lens with a narrower angle of view and a higher magnification than the wide-angle imaging unit and mounted rotatably to the imaging apparatus, the imaging apparatus comprising:
a driving unit that rotates the zoom imaging unit so as to change an imaging range of the zoom imaging unit;
an image comparison unit that compares a partial image of a wide-angle image captured by the wide-angle imaging unit and a magnified image captured by the zoom imaging unit; and
an optical axis information update unit that updates optical axis information of the zoom imaging unit based on a comparison result of the image comparison unit.

2. The imaging apparatus according to claim 1, wherein the image comparison unit performs mosaicing of the wide-angle image and the magnified image to substantially equalize a viewing angle per pixel, compares the partial image of the wide-angle image and the magnified image and derives a degree of agreement in tone in pixels between the images.

3. The imaging apparatus according to claim 2, wherein the optical axis information update unit updates the optical axis information of the zoom imaging unit based on coordinate information of the partial image having a maximum value of the degree of agreement in tone in pixels between the partial image of the wide-angle image and the magnified image.

4. The imaging apparatus according to claim 3, wherein if there is one maximum value of the degree of agreement in tone in pixels between the partial image of the wide-angle image and the magnified image, the optical axis information update unit updates the optical axis information of the zoom imaging unit based on coordinate information of the partial image having the maximum value.

5. The imaging apparatus according to claim 3, wherein if a difference between a maximum value of the degree of agreement in tone in pixels between the partial image of the wide-angle image and the magnified image and a second maximum value of the degree of agreement is equal to or larger than a threshold, the optical axis information update unit updates the optical axis information of the zoom imaging unit based on coordinate information of the partial image having the maximum value.

6. The imaging apparatus according to claim 1, wherein the optical axis information update unit updates the optical axis information of the zoom imaging unit at regular time intervals.

7. The imaging apparatus according to claim 1, further comprising:
a moving subject detection unit,
wherein the image comparison unit compares the partial image in a range where a moving subject is detected by the moving subject detection unit within the wide-angle image and the magnified image.

8. The imaging apparatus according to claim 1, further comprising:
a light shielding element that shields at least part of a range that can be imaged by the zoom imaging unit in an arc shape; and
a reference position acquisition unit that acquires a reference position of the zoom imaging unit based on coordinate information of the light shielding element appearing in the magnified image captured by the zoom imaging unit.

9. The imaging apparatus according to claim 1, further comprising:
an image storage unit that stores image data captured by the zoom imaging unit and position information of the image data obtained from a rotating state of the zoom imaging unit in association with each other; and
an image composition unit that combines a plurality of image data and generates image data over a wide range based on a plurality of image data with different imaging ranges and the position information of the image data stored in the image storage unit.

10. The imaging apparatus according to claim 9, further comprising:
an initialization control unit that controls initialization processing that divides a whole area of an imaging range of the wide-angle imaging unit into a plurality of imaging ranges, sequentially images the plurality of imaging ranges using the zoom imaging unit by rotating the zoom imaging unit using the driving unit, and stores a plurality of image data captured by the zoom imaging unit in association with the position information of the image data into the image storage unit.

11. An imaging apparatus including a plurality of imaging units each having a lens and an image pickup device, at least one of the plurality of imaging units being a wide-angle imaging unit having a lens with a wider angle of view than another imaging unit, and at least one of the plurality of imaging units being a zoom imaging unit having a lens with a narrower angle of view and a higher magnification than the wide-angle imaging unit and mounted rotatably to the imaging apparatus, the imaging apparatus comprising:
a driving unit that rotates the zoom imaging unit so as to change an imaging range of the zoom imaging unit; and
a light shielding element that shields at least part of a range that can be imaged by the zoom imaging unit in an arc shape.

12. The imaging apparatus according to claim 11, further comprising:
a reference position acquisition unit that acquires a reference position of the zoom imaging unit based on coordinate information of the light shielding element appearing in a magnified image captured by the zoom imaging unit.

13. The imaging apparatus according to claim 12, further comprising:
an image storage unit that stores image data captured by the zoom imaging unit and position information of the image data obtained from a rotating state of the zoom imaging unit in association with each other; and
an image composition unit that combines a plurality of image data and generates image data over a wide range based on a plurality of image data with different imaging ranges and the position information of the image data stored in the image storage unit.

14. The imaging apparatus according to claim 13, further comprising:
an initialization control unit that controls initialization processing that divides a whole area of an imaging range of the wide-angle imaging unit into a plurality of imaging ranges, sequentially images the plurality of imaging ranges using the zoom imaging unit by rotating the zoom imaging unit using the driving unit, and stores a plurality of image data captured by the zoom imaging unit in association with the position information of the image data into the image storage unit.

15. An optical axis correction method of an imaging apparatus including a wide-angle imaging unit and a zoom imaging unit with a narrower angle of view and a higher magnification than the wide-angle imaging unit, the method comprising steps of:
capturing a wide-angle image by the wide-angle imaging unit;
capturing a magnified image by the zoom imaging unit;
performing mosaicing of the wide-angle image and the magnified image to substantially equalize a viewing angle per pixel;
extracting a partial image from the mosaiced wide-angle image;
comparing the partial image and the mosaiced magnified image and deriving a degree of agreement in tone in pixels between the images; and
updating optical axis information of the zoom imaging unit based on the degree of agreement.

16. The optical axis correction method according to claim 15, wherein the comparing step compares the partial image in a range where a moving subject is detected within the wide-angle image and the magnified image.
